(19) United States
(12) Patent Application Publication
(10) Pub. No.: US 2021/0129536 A1
(43) Pub. Date: May 6, 2021

(54) SLIDABLE SERVICE ASSEMBLIES

(71) Applicant: Hewlett-Packard Development Company, L.P., Spring, TX (US)

(72) Inventors: Si-lam Choy, Corvallis, OR (US); Michael W. Cumbie, Corvallis, OR (US)

(73) Assignee: Hewlett-Packard Development Company, L.P., Spring, TX (US)

(21) Appl. No.: 16/640,751

(22) PCT Filed: Oct. 10, 2017
(86) PCT No.: PCT/US2017/055875

§ 371 Date: Feb. 21, 2020

(51) Int. Cl. B41J 2/165

(52) U.S. Cl. CPC B41J 2/16505; B41J 2/16547; B41J 2/16538

(57) ABSTRACT

A fluid ejection device includes a fluid ejection assembly including a fluid ejection die, and a service assembly to be slid relative to the fluid ejection assembly between a service position for service of the fluid ejection die and a retracted position nested with the fluid ejection assembly.

### Background

A fluid ejection die, such as a printhead die in an inkjet printing system, may use thermal resistors or piezoelectric material membranes as actuators within fluidic chambers to eject fluid drops (e.g., ink) from nozzles, such that properly sequenced ejection of ink drops from the nozzles causes characters or other images to be printed on a print medium as the printhead die and the print medium move relative to each other.

### BRIEF DESCRIPTION OF THE DRAWINGS

FIG. 1 is a schematic view illustrating an example of a fluid ejection device.

FIG. 2 is a block diagram illustrating an example of an inkjet printing system including an example of a fluid ejection device.

FIGS. 3a, 3b, 3c are perspective views illustrating an example of a fluid ejection device including an example of a fluid ejection assembly and an example of a service assembly for the fluid ejection assembly in different positions.

FIG. 4 is a perspective view illustrating an example of the service assembly of the fluid ejection device of FIGS. 3a, 3b, 3c.

FIG. 5 is an exploded perspective view illustrating an example of the service assembly of FIG. 4.

FIGS. 6a, 6b, 6c are side views illustrating an example of the fluid ejection device of FIGS. 3a, 3b, 3c including an example of the service assembly in different positions.

FIG. 7 is a perspective view illustrating an example of the fluid ejection device of FIG. 3a including an example of the fluid ejection assembly and an example of a portion of the service assembly.

FIG. 8 is a perspective view illustrating an example of the fluid ejection device of FIG. 3b including an example of the fluid ejection assembly and an example of a portion of the service assembly.

FIGS. 9a, 9b are side views illustrating an example of a fluid ejection device including an example of a fluid ejection assembly and an example of a service assembly for the fluid ejection assembly in a position for service of the fluid ejection assembly and a position for ejection of fluid from the fluid ejection assembly, respectively.

FIG. 10 is a flow diagram illustrating an example of a method of servicing a fluid ejection assembly.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

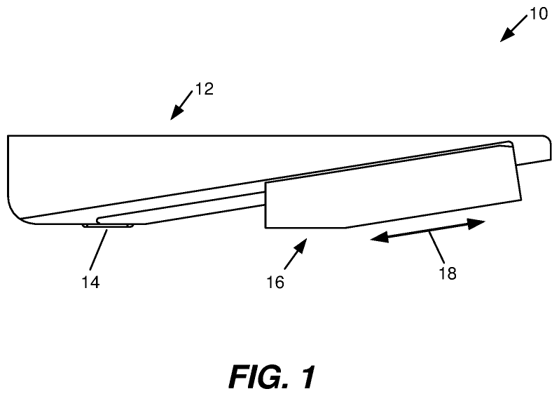

As illustrated in the example of FIG. 1, the present disclosure provides a fluid ejection device 10. In one implementation, the fluid ejection device 10 includes a fluid ejection assembly 12 including a fluid ejection die 14, and a service assembly 16 to be slid relative to the fluid ejection assembly 12, as represented, for example, by arrow 18, between a service position for service of the fluid ejection die 14, such as capping and/or wiping, and a retracted position nested with the fluid ejection assembly 12.

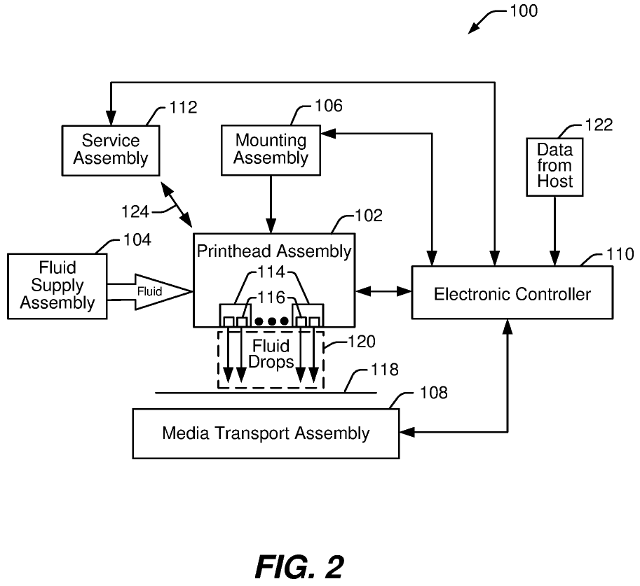

FIG. 2 illustrates an example of an inkjet printing system 100 including an example of a fluid ejection device, as disclosed herein. Inkjet printing system 100 includes a printhead assembly 102, as an example of a fluid ejection assembly, a fluid (ink) supply assembly 104, a mounting assembly 106, a media transport assembly 108, an electronic controller 110, and a service assembly 112.

Printhead assembly 102 includes at least one printhead die 114, as an example of a fluid ejection die, that ejects drops of fluid (ink) through a plurality of orifices or nozzles 116 toward a print medium 118 so as to print on print media 118. Nozzles 116 are typically arranged in one or more columns or arrays such that properly sequenced ejection of fluid (ink) from nozzles 116 causes characters, symbols, and/or other graphics or images to be printed on print media 118 as printhead assembly 102 and print media 118 are moved relative to each other. Print media 118 can be any type of suitable sheet or roll material, such as paper, card stock, transparencies, Mylar, and the like, and may include rigid or semi-rigid material, such as cardboard or other panels.

Fluid (ink) supply assembly 104 supplies fluid (ink) to printhead assembly 102 such that fluid flows from fluid (ink) supply assembly 104 to printhead assembly 102. In one example, printhead assembly 102 and fluid (ink) supply assembly 104 are housed together in an inkjet cartridge or pen. In another example, fluid (ink) supply assembly 104 is separate from printhead assembly 102 and supplies fluid (ink) to printhead assembly 102 through an interface connection, such as a supply tube. In either example, fluid (ink) supply assembly 104 may be removed, replaced, and/or refilled.

Mounting assembly 106 positions printhead assembly 102 relative to media transport assembly 108, and media transport assembly 108 positions print media 118 relative to printhead assembly 102. Thus, a print zone 120 is defined adjacent to nozzles 116 in an area between printhead assembly 102 and print media 118. In one example, printhead assembly 102 is a scanning type printhead assembly. As such, mounting assembly 106 includes a carriage for moving printhead assembly 102 relative to media transport assembly 108 to scan print media 118. In another example, printhead assembly 102 is a non-scanning type printhead assembly. As such, mounting assembly 106 fixes printhead assembly 102 at a prescribed position relative to media transport assembly 108.

Electronic controller 110 typically includes a processor, firmware, software, one or more memory components including volatile and non-volatile memory components, and other printer electronics for communicating with and controlling printhead assembly 102, mounting assembly 106, media transport assembly 108, and service assembly 112. Electronic controller 110 receives data 122 from a host system, such as a computer, and temporarily stores data 122 in a memory. Data 122 may be received via an electronic, infrared, optical, or other information transfer path. Data 122 represents, for example, a document and/or file to be printed. As such, data 122 forms a print job for inkjet printing system 100 and includes one or more print job commands and/or command parameters.

In one example, electronic controller 110 controls printhead assembly 102 for ejection of fluid (ink) drops from nozzles 116. Thus, electronic controller 110 defines a pattern of ejected fluid (ink) drops which form characters, symbols, and/or other graphics or images on print media 118. The pattern of ejected fluid (ink) drops is determined by the print job commands and/or command parameters.

Service assembly 112 provides for wiping, capping, spitting, and/or priming of printhead assembly 102 in order to maintain a functionality of printhead assembly 102, including, more specifically, nozzles 116 of printhead die 114. For example, service assembly 112 may include a rubber blade or wiper which periodically contacts and passes over printhead assembly 102 to wipe and clean nozzles 116 of excess ink. In addition, service assembly 112 may include a cap which covers printhead assembly 102 to protect nozzles 116 from drying out during periods of non-use. In addition, service assembly 112 may include a spittoon or absorbent material into which printhead assembly 102 ejects (i.e., spits or purges) ink to insure that fluid (ink) supply assembly 104 maintains an appropriate level of pressure and fluidity, and insure that nozzles 116 do not clog or weep. Functions of service assembly 112 may include relative motion between service assembly 112 and printhead assembly 102. In one implementation, service assembly 112 is slidable relative to printhead assembly 102, as represented, for example, by arrow 124, to position service assembly 112 for service of printhead assembly 102, including, more specifically, service of printhead die 114 of printhead assembly 102, and to nest service assembly 112 with printhead assembly 102.

Printhead assembly 102 includes one (i.e., a single) printhead die 114 or more than one (i.e., multiple) printhead die 114. In one example, printhead assembly 102 is a wide-array or multi-head printhead assembly. In one implementation of a wide-array assembly, printhead assembly 102 includes a carrier that carries a plurality of printhead dies 114, provides electrical communication between printhead dies 114 and electronic controller 110, and provides fluidic communication between printhead dies 114 and fluid (ink) supply assembly 104.

In one example, inkjet printing system 100 is a drop-on-demand thermal inkjet printing system wherein printhead assembly 102 includes a thermal inkjet (TIJ) printhead that implements a thermal resistor as a drop ejecting element to vaporize fluid (ink) in a fluid chamber and create bubbles that force fluid (ink) drops out of nozzles 116. In another example, inkjet printing system 100 is a drop-on-demand piezoelectric inkjet printing system wherein printhead assembly 102 includes a piezoelectric inkjet (PIJ) printhead that implements a piezoelectric actuator as a drop ejecting element to generate pressure pulses that force fluid (ink) drops out of nozzles 116.

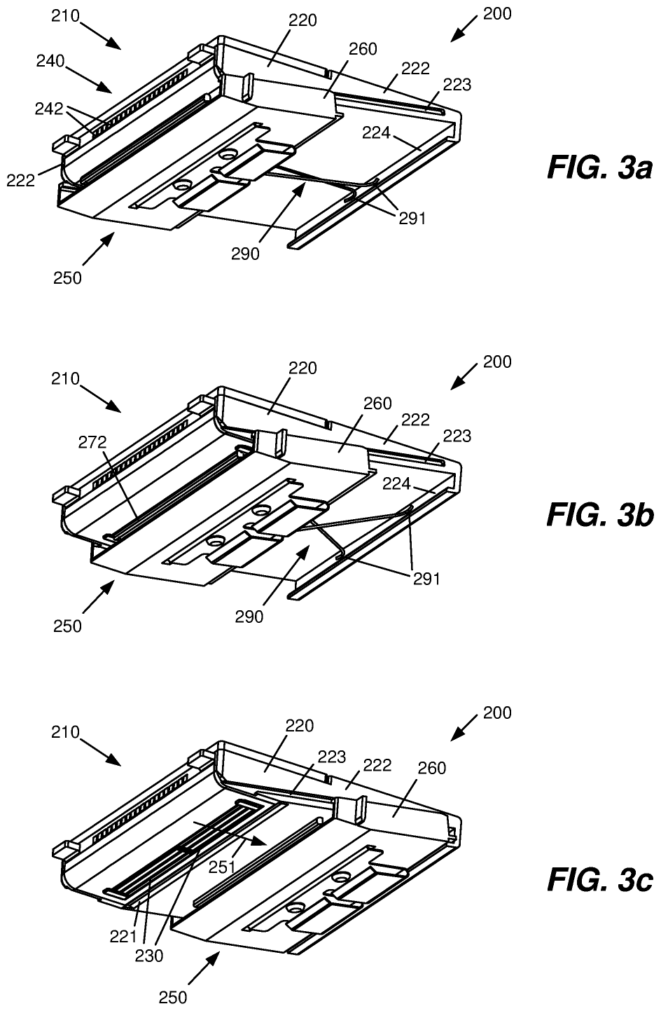

FIGS. 3a, 3b, 3c are perspective views illustrating an example of a fluid ejection device 200 in accordance with the present disclosure. In the illustrated example, fluid ejection device 200 includes a fluid ejection assembly 210, as an example of printhead assembly 102 (FIG. 2), and a service assembly 250, as an example of service assembly 112 (FIG. 2). As disclosed herein, service assembly 250 is slidable relative to fluid ejection assembly 210 between a service position for service of fluid ejection assembly 210 and a retracted position nested with fluid ejection assembly 210.

In one example, fluid ejection assembly 210 includes a housing or body 220, a fluid ejection die 230, and an electrical circuit 240 such that fluid ejection die 230 is supported by body 220 and electrically coupled with electrical circuit 240. In one implementation, fluid ejection die 230, as an example of printhead die 114 (FIG. 2), includes a drop-on-demand thermal inkjet (TIJ) printhead, as described above. In another implementation, fluid ejection die 230, as an example of printhead die 114 (FIG. 2), includes a drop-on-demand piezoelectric inkjet (PIJ) printhead, as described above. In either example, fluid ejection die 230 includes orifices or nozzles, such as orifices or nozzles 116 (FIG. 2), through which drops of fluid (ink) are ejected, as described above. In one example, fluid ejection die 230 includes a thin-film structure formed on a substrate with the substrate formed, for example, of silicon, glass, or a stable polymer, and the thin-film structure including conductive, passivation or insulation layers.

In one example, body 220 supports fluid ejection die 230 and includes a reservoir of fluid, such as fluid supply assembly 104 (FIG. 2), which communicates with and supplies fluid (ink) to fluid ejection die 230. In addition, body 220 supports electrical circuit 240 which facilitates communication of electrical signals between an electronic controller, such as electronic controller 110 (FIG. 2), and fluid ejection die 230 for controlling and/or monitoring operation of fluid ejection die 230.

In one example, fluid ejection die 230 may be supplied with more than one type or color of fluid (e.g., fluids of different dyes, pigments, constituents, substances, agents, reactants, reagents, or colors) and may include a column (or columns) of orifices or nozzles for each type or color of fluid. In some examples, fluid ejection die 230 may eject different colors of fluid (e.g., cyan, magenta, yellow, and black ink). In other examples, fluid ejection die 230 may eject at least two types of fluid. For example, fluid ejection die 230 may correspond to a lab-on-a-chip device, where a first fluid may be a reagent, and a second fluid may be a solution including test material therein.

In one example, electrical circuit 240 includes a plurality of electrical contacts 242 and a plurality of conductive paths which extend between and provide electrical connection between electrical contacts 242 and fluid ejection die 230. Electrical contacts 242 provide points for electrical connection to fluid ejection assembly 210 and, more specifically, fluid ejection die 230. As such, electrical contacts 242 facilitate communication of power, ground, and/or data signals with fluid ejection die 230. In one implementation, electrical circuit 240 is supported by body 220 such that electrical contacts 242 are provided at end of body 220.

In one example, electrical circuit 240 is a flexible electrical circuit with conductive paths formed in or on a flexible base material. The flexible base material may include, for example, a polyimide or other flexible polymer material (e.g., polyester, poly-methyl-methacrylate), and the conductive paths may be formed of copper, gold, or other conductive material.

In one implementation, fluid ejection assembly 210 includes multiple fluid ejection die 230 supported by body 220 such that fluid ejection assembly 210 provides a wide-array (e.g., page-wide array) printhead assembly. As a wide-array or multi-head printhead assembly, the multiple fluid ejection die 230 of fluid ejection assembly 210 are arranged and aligned in one or more staggered or overlapping rows such that a fluid ejection die 230 in one row overlaps at least one fluid ejection die 230 in another row. As such, fluid ejection assembly 210 may span a nominal page width or a width shorter or longer than a nominal page width.

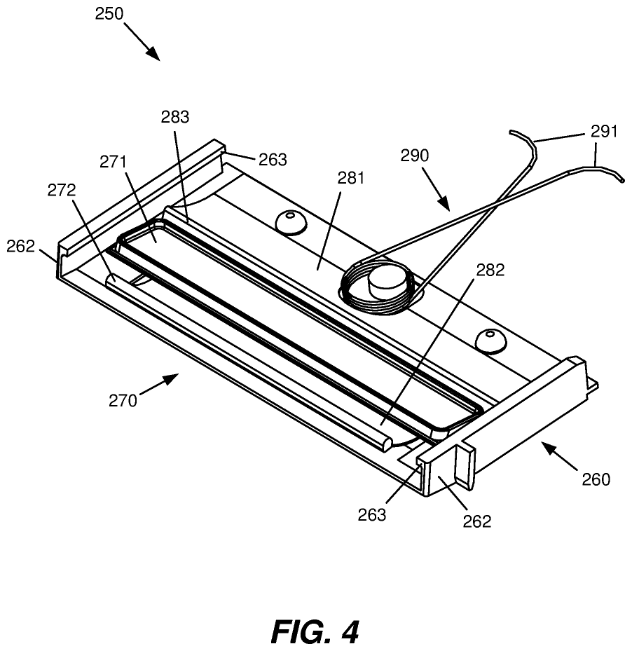

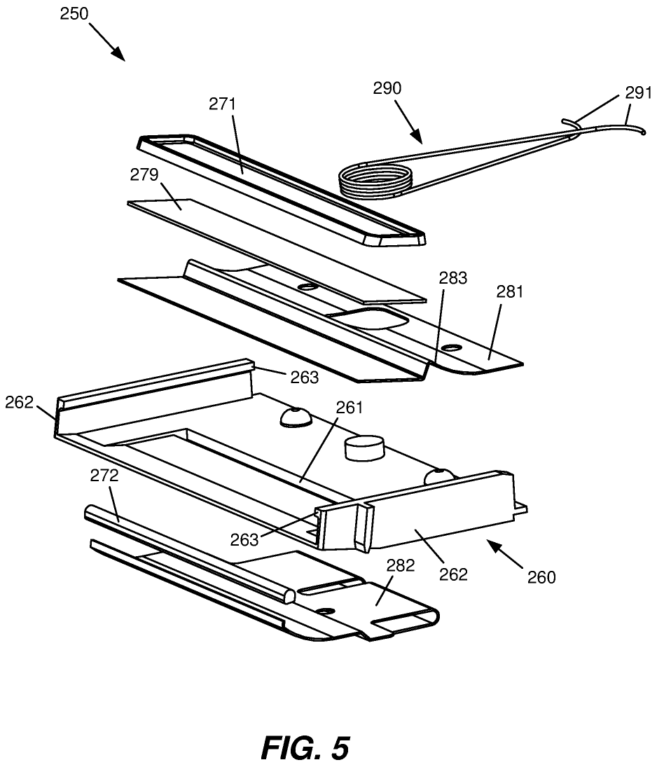

FIG. 4 is a perspective view illustrating an example of service assembly 250, and FIG. 5 is an exploded perspective view illustrating an example of service assembly 250. In the illustrated example, service assembly 250 includes a sled 260 and servicing components 270 supported by sled 260. In one implementation, servicing components 270 include a cap 271 and a wiper 272. In one example, cap 271 is formed of a rubber material and sized to fit around a perimeter of fluid ejection die 230 such that cap 271 covers fluid ejection die 230 including, more specifically, a front face of fluid ejection die 230, to protect nozzles or orifices of fluid ejection die 230 from drying out during periods of non-use. In one example, wiper 272 includes an elastomer tip which is periodically contacted with and passed over fluid ejection die 230 including, more specifically, a front face of fluid ejection die 230, to wipe and clean orifices or nozzles of fluid ejection die 230 of excess fluid (ink).

In one implementation, cap 271 is mounted on or supported by a leaf spring 281 which is secured to sled 260, and wiper 272 is mounted on or supported by a leaf spring 282 which is secured to sled 260. In one example, cap 271 is provided at an edge of leaf spring 281 along a width of leaf spring 281. In one example, wiper 272 is provided at an edge of leaf spring 282 along a width of leaf spring 282. In one example, cap 271 is secured to leaf spring 281 by an adhesive tape 279.

In one implementation, leaf spring 281 and leaf spring 282 are each plate springs and are secured to opposite sides of sled 260. In one example, leaf spring 282 extends through an opening or slot 261 provided in sled 260 such that cap 271 and wiper 272 are positioned on a same side of sled 260.

In one example, sled 260, with servicing components 270, is biased, for example, by a bias spring 290, to a default position, as described below.

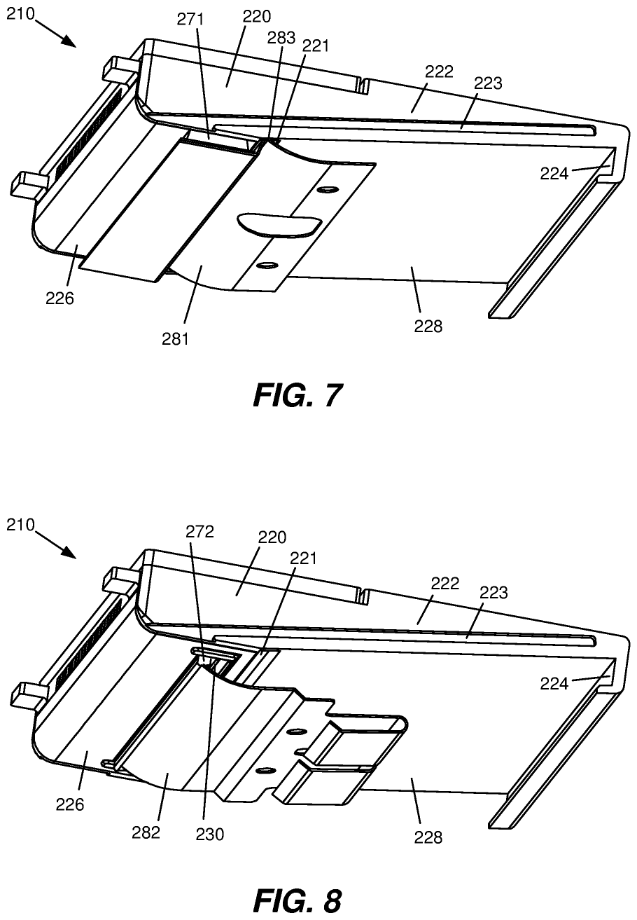

In one example, leaf spring 281 includes a ramped surface or feature 283 extended substantially parallel with cap 271. In one implementation, ramped surface or feature 283 extends a width of leaf spring 281 along a width of cap 271. As such, ramped surface or feature 283 contacts body 220 of fluid ejection assembly 210 to lift or space cap 271 relative to fluid ejection die 230 and help prevent cap 271 from sliding across a front face of fluid ejection die 230 as cap 271 is positioned over the front face of fluid ejection die 230. In one implementation, body 220 includes a corresponding recess or recessed feature 221 (FIG. 3c, 7, 8) which receives ramped surface or feature 283 such that cap 271 may be sealed over the front face of fluid ejection die 230 when cap 271 is positioned over the front face of fluid ejection die 230 (see, e.g., FIGS. 3a, 7).

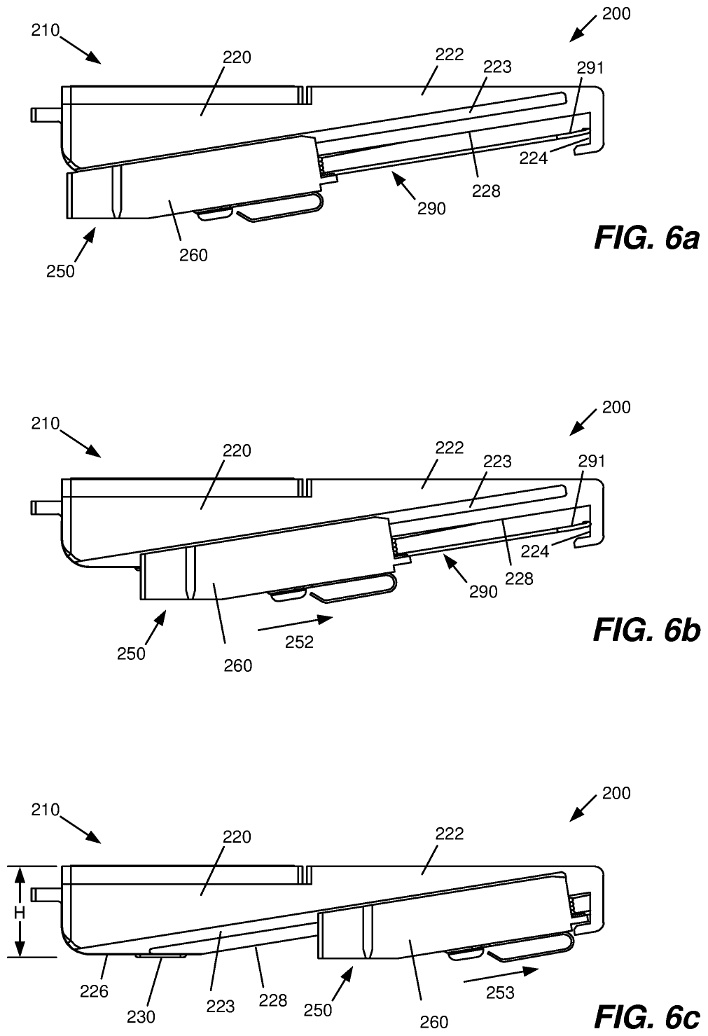

In one implementation, as illustrated in the example of FIGS. 3a, 3b, 3c and the example of FIGS. 6a, 6b, 6c, service assembly 250 is moved relative to fluid ejection assembly 210 to establish different positions of service assembly 250. More specifically, service assembly 250 is slid relative to fluid ejection assembly 210 to position service assembly 250 for service of fluid ejection assembly 210, including, more specifically, service of fluid ejection die 230 of fluid ejection assembly 210, and to position service assembly 250 for ejection of fluid from fluid ejection assembly 210. In one example, service assembly 250, including, more specifically, sled 260 with servicing components 270, is slid relative to fluid ejection assembly 210 in a direction substantially perpendicular to a column (or columns) of orifices or nozzles of fluid ejection die 230 (as represented, for example, by arrow 251).

In one example, sled 260 of service assembly 250 is slidably mounted on body 220 of fluid ejection assembly 210 to facilitate moving of service assembly 250 to different positions relative to fluid ejection assembly 210. For example, in one implementation, sled 260 and body 220 include corresponding and mating sliding engagement features, such as lips or protrusions 263 provided at or along opposite sides 262 of sled 260 (FIGS. 4, 5) and grooves or channels 223 provided in or along opposite sides 222 of body 220 (FIGS. 7, 8). As such, sled 260 is slidable relative to body 220 to establish different positions of service assembly 250, as described below.

FIGS. 3a and 6a are perspective and side views, respectively, illustrating an example of service assembly 250 of fluid ejection device 200 in a position for service of fluid ejection assembly 210. More specifically, FIGS. 3a and 6a illustrate an example of service assembly 250 in a position to service fluid ejection die 230 with cap 271 and cover or cap fluid ejection die 230 (i.e., a capped position). As such, in the capped position, cap 271 covers fluid ejection die 230 to protect orifices or nozzles of fluid ejection die 230 from drying out during periods of non-use.

For example, FIG. 7 is a perspective view illustrating an example of service assembly 250 in the capped position (with sled 260, leaf spring 282, and wiper 272 removed for illustration purposes). As illustrated in the example of FIG. 7, leaf spring 281 provides a biasing force to cap 271 to cover a front face of fluid ejection die 230.

In one implementation, service assembly 250 is biased to the capped position of FIGS. 3a and 6a, for example, by bias spring 290, such that the capped position of FIGS. 3a and 6a represents a default position of service assembly 250. In one example, ends 291 of bias spring 290 contact and fit within a channel 224 provided along an end of body 220.

FIGS. 3b and 6b are perspective and side views, respectively, illustrating an example of service assembly 250 of fluid ejection device 200 in another position for service of fluid ejection assembly 210. More specifically, FIGS. 3b and 6b illustrate an example of service assembly 250 in a position to service fluid ejection die 230 with wiper 272 and wipe fluid ejection die 230 (i.e., a wipe position). As such, in and through the wipe position, wiper 272 contacts and passes over fluid ejection die 230 to wipe or clean orifices or nozzles of fluid ejection die 230.

For example, FIG. 8 is a perspective view illustrating an example of service assembly 250 in the wipe position (with sled 260, leaf spring 281, and cap 271 removed for illustration purposes). As illustrated in the example of FIG. 8, leaf spring 282 provides a biasing force to wiper 272 to wipe a front face of fluid ejection die 230.

In one implementation, service assembly 250 is moved (e.g., to the right in the illustrated example as represented by arrow 252) to remove cap 271 from fluid ejection die 230, and to move wiper 272 across a front face of fluid ejection die 230 through and to establish the wipe position. In one example, service assembly 250 is moved, for example, against the biasing force of bias spring 290 such that ends 291 of bias spring 290 slide within channel 224 of body 220.

FIGS. 3c and 6c are perspective and side views, respectively, illustrating an example of service assembly 250 of fluid ejection device 200 in a position for fluid ejection by fluid ejection assembly 210. More specifically, FIGS. 3c and 6c illustrate an example of service assembly 250 in a position to allow ejection of fluid from fluid ejection die 230 (i.e., an ejection (or print) position). As such, in the ejection (or print) position, drops of fluid may be ejected from fluid ejection die 230.

In one implementation, service assembly 250 is moved (e.g., to the right in the illustrated example as represented by arrow 253) to retract service assembly 250 and establish the ejection (or print) position. In one example, service assembly 250 is moved, for example, against the biasing force of bias spring 290 such that ends 291 of bias spring 290 slide and spread from each other within channel 224 of body 220.

In one implementation, after ejection of fluid from fluid ejection die 230, service assembly 250 is returned to the default position (e.g., the capped position of FIG. 3a, 6a). Service assembly 250 is returned to the default position, for example, by bias spring 290.

In one implementation, as illustrated in the example of FIGS. 6a, 6b, 6c, body 220 includes a portion having a planar or flat surface 226 on which fluid ejection die 230 is supported, and a tapered portion having a ramped surface 228 along which service assembly 250, including, more specifically, sled 260 with servicing components 270, is supported (see also FIGS. 7, 8). As such, sled 260, with servicing components 270, is slid along or relative to ramped surface 228 of body 220 for different service operations of fluid ejection die 230 and for ejection of fluid from fluid ejection die 230, as described above.

For example, as illustrated in the example of FIG. 6c, service assembly 250 is retracted relative to fluid ejection assembly 210 (e.g., moved to the right in the illustrated example as represented by arrow 253) for ejection of fluid from fluid ejection die 230. As such, in the retracted position, service assembly 250 is nested with fluid ejection assembly 210. More specifically, in the retracted position, service assembly 250 is positioned within a height H of fluid ejection assembly 210. As such, a low profile of fluid ejection device 200 for ejection of fluid from fluid ejection assembly 210 is provided.

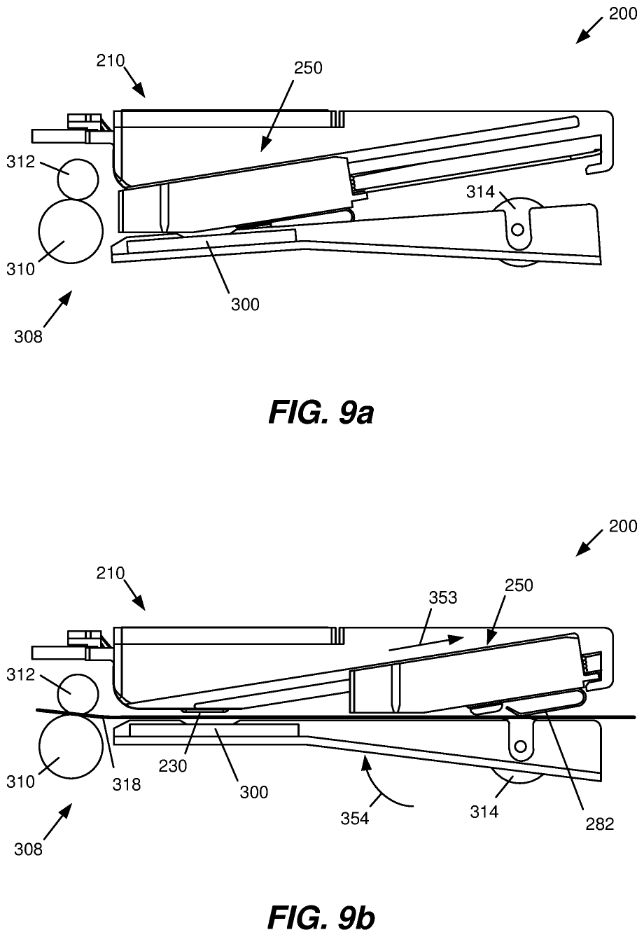

FIGS. 9a, 9b are side views illustrating an example of fluid ejection device 200 including an example of service assembly 250 in, respectively, a position for service of fluid ejection assembly 210 and a position for ejection of fluid from fluid ejection assembly 210, including, more specifically, ejection of fluid from fluid ejection die 230 of fluid ejection assembly 210. In the example of FIGS. 9a, 9b, fluid ejection device 200 is implemented in a printer which, in addition to fluid ejection device 200, includes a platen 300 for supporting print media 318, as an example of print media 118 (FIG. 2), and a media transport assembly 308, as an example of media transport assembly 108 (FIG. 2), for positioning print media 318 relative to fluid ejection assembly 210.

In one implementation, platen 300 is pivotable relative to fluid ejection assembly 210. More specifically, as service assembly 250 is retracted, for example, from the capped position of FIG. 9a to the print position of FIG. 9b (e.g., moved to the right in the illustrated example as represented by arrow 353), platen 300 is pivoted toward fluid ejection assembly 210 (e.g., rotated clockwise in the illustrated example as represented by arrow 354). As such, platen 300 is positioned to support print media 318 as print media 318 is positioned by media transport assembly 308.

In one implementation, to guide and/or route print media 318, media transport assembly 308 includes a drive roller 310, an opposing pinch roller 312, and an output roller 314. In one example, an end of leaf spring 282 of service assembly 250 is biased against output roller 314 to maintain tension on print media 318 as print media 318 is routed by media transport assembly 308. Although one drive roller 310, one pinch roller 312, and one output roller 314 are illustrated and described, multiple drive rollers 310, multiple pinch rollers 312, and/or multiple output rollers 314 may be provided.

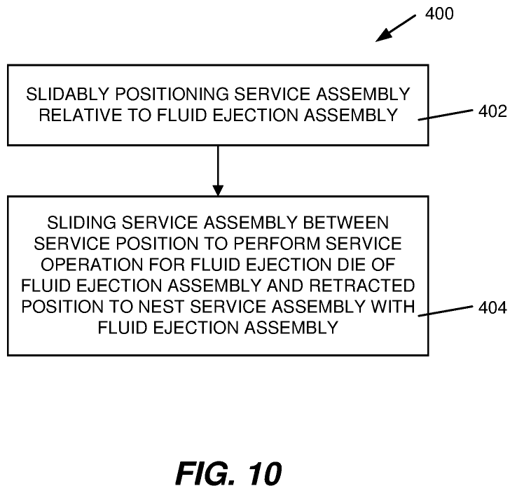

FIG. 10 is a flow diagram illustrating an example of a method 400 of servicing a fluid ejection assembly, such as fluid ejection assembly 210 of fluid ejection device 200, as illustrated in the example of FIGS. 3a, 3b, 3c, and FIGS. 6a, 6b, 6c. At 402, method 400 includes slidably positioning a service assembly relative to the fluid ejection assembly, such as slidably positioning service assembly 250 relative to fluid ejection assembly 210. And, at 404, method 400 includes sliding the service assembly between a service position to perform a service operation for a fluid ejection die of the fluid ejection assembly and a retracted position to nest the service assembly with the fluid ejection assembly, such as sliding service assembly 250 between a service position to perform a service operation for fluid ejection die 230 of fluid ejection assembly 210 and a retracted position to nest service assembly 250 with fluid ejection assembly 210.

In one example, slidably positioning a service assembly relative to the fluid ejection assembly, at 402, includes positioning the service assembly in a position to cap the fluid ejection die of the fluid ejection assembly, such as positioning service assembly 250 in the capped position of FIGS. 3a and 6a.

In one example, slidably positioning a service assembly relative to the fluid ejection assembly, at 402, includes positioning the service assembly in a position to wipe the fluid ejection die of the fluid ejection assembly, such as positioning service assembly 250 in the wipe position of FIGS. 3b and 6b.

In one example, sliding the service assembly between a service position to perform a service operation for a fluid ejection die of the fluid ejection assembly and a retracted position to nest the service assembly with the fluid ejection assembly, at 404, includes sliding the service assembly to the retracted position to eject drops of fluid from the fluid ejection die, such as sliding service assembly 250 between the capped position of FIGS. 3a and 6a or the wipe position of FIGS. 3b and 6b and the retracted position of FIGS. 3c and 6c.

By slidably supporting service assembly 250 on fluid ejection assembly 210, as disclosed herein, an integrated fluid ejection device 200 with a compact or reduced form factor may be achieved. As such, fluid ejection device 200, as disclosed herein, may be implemented, for example, in a pocket-sized printer.

Example fluid ejection devices, as described herein, may be implemented in printing devices, such as two-dimensional printers and/or three-dimensional printers (3D). As will be appreciated, some example fluid ejection devices may be printheads. In some examples, a fluid ejection device may be implemented into a printing device and may be utilized to print content onto a media, such as paper, a layer of powder-based build material, reactive devices (such as lab-on-a-chip devices), etc. Example fluid ejection devices include ink-based ejection devices, digital titration devices, 3D printing devices, pharmaceutical dispensation devices, lab-on-chip devices, fluidic diagnostic circuits, and/or other such devices in which amounts of fluids may be dispensed/ejected.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. A fluid ejection device, comprising:
a fluid ejection assembly including a fluid ejection die; and
a service assembly to be slid relative to the fluid ejection assembly between a service position for service of the fluid ejection die and a retracted position nested with the fluid ejection assembly.

2. The fluid ejection device of claim 1, the service assembly to be slid relative to the fluid ejection assembly along a ramped surface of the fluid ejection assembly.

3. The fluid ejection device of claim 1, in the retracted position, the service assembly to be positioned within a height of the fluid ejection assembly.

4. The fluid ejection device of claim 1, the fluid ejection die including a column of fluid ejection orifices, and the service assembly to be slid relative to the fluid ejection assembly in a direction substantially perpendicular to the column of fluid ejection orifices.

5. The fluid ejection device of claim 1, the service assembly to be slid to the retracted position for ejection of fluid from the fluid ejection die.

6. The fluid ejection device of claim 1, the fluid ejection assembly including a body having a first portion supporting the fluid ejection die and a second portion tapered from the first portion, and the service assembly to be slid along the second portion of the body.

7. A fluid ejection device, comprising:
a body having a ramped surface and supporting a fluid ejection die; and
a sled slidably mounted on the body, the sled slidable relative to the ramped surface and supporting at least one of a cap to cover the fluid ejection die and a wiper to wipe the fluid ejection die.

8. The fluid ejection device of claim 7, the sled slidable relative to the ramped surface to position the sled to service the fluid ejection die with at least one of the cap and the wiper.

9. The fluid ejection device of claim 7, the sled slidable relative to the ramped surface to move the sled away from the fluid ejection die.

10. The fluid ejection device of claim 7, the sled slidable relative to the ramped surface to nest the sled with the body.

11. The fluid ejection device of claim 7, further comprising:
a first leaf spring extending from the sled, the first leaf spring supporting one of the cap and the wiper; and
a second leaf spring extending from the sled, the second leaf spring supporting the other of the cap and the wiper.

12. A method of servicing a fluid ejection assembly, comprising:
slidably positioning a service assembly relative to the fluid ejection assembly; and
sliding the service assembly between a service position to perform a service operation for a fluid ejection die of the fluid ejection assembly and a retracted position to nest the service assembly with the fluid ejection assembly.

13. The method of claim 12, wherein sliding the service assembly includes sliding the service assembly along a ramped surface of the fluid ejection assembly.

14. The method of claim 12, wherein sliding the service assembly includes sliding the service assembly to the retracted position to eject drops of fluid from the fluid ejection die.

15. The method of claim 12, wherein sliding the service assembly to the retracted position includes positioning the service assembly within a height of the fluid ejection assembly.
